(19) United States
(12) Patent Application Publication
(10) Pub. No.: US 2026/0216736 A1
(43) Pub. Date: Jul. 30, 2026

(54) SULFUR COMPOSITIONS FOR FROTH FLOTATION OF ORES

(71) Applicant: Arkema Inc., King of Prussia, PA (US)

(72) Inventors: Carlos F. BUITRAGO, King of Prussia, PA (US); Jean-Philippe R. CHAUVIN, King of Prussia, PA (US)

(21) Appl. No.: 19/141,120

(22) PCT Filed: Nov. 30, 2023
(86) PCT No.: PCT/US2023/081762

§ 371 Date: Jun. 19, 2025

Related U.S. Application Data
(60) Provisional application No. 63/434,110, filed on Dec. 21, 2022.

(51) Int. Cl. B03D 1/012

(52) U.S. Cl. CPC B03D 1/012

(57) ABSTRACT

A composition for flotation separation of minerals in ore is provided. The composition is mercaptan-based and includes a) at least one mercaptan having a structure i), or ii), R¹R²—CH—SH i) or R³—CH₂—SH ii) or combination thereof and; b) one or more aromatic, aliphatic or polyalkylene oxide compounds. Another composition for flotation separation of minerals in ore is also provided. This flotation composition is thiocarbonate-based and includes d) at least one trithiocarbonate having a structure R¹R²—CH—S—C(═S)—SH or salt thereof; or R³—CH₂—S—C(═S)—SH or salt thereof; or combination thereof; and b) one or more aromatic, aliphatic or polyalkylene oxide compounds. Processes for flotation separation of minerals in an ore utilizing these flotation compositions are also provided.

### FIELD OF THE INVENTION

This invention relates to compositions and methods useful for the froth flotation separation of minerals in ores.

### BACKGROUND

Froth flotation, or flotation, is a process of extracting a metal from low-content ores by a stage of concentration. This stage comes before a subsequent treatment comprising the heat treatment (also known as smelting) or the leaching and the refining. This is in particular the case with ores of oxides and/or sulfides of lead, zinc, copper, silver, gold, molybdenum, nickel, cobalt, iron, and metals belonging to the platinum group: platinum, palladium, rhodium, ruthenium, iridium and osmium.

Flotation is a method that concentrates and separates the valuable components of an ore from the undesirable components, “gangue,” to produce a mineral concentrate that is fed to pyrometallurgical or hydro-metallurgical operations. The process of froth flotation starts by crushing ore into fine particles to provide separate particles of desirable minerals and the undesirable gangue components, and then frothing or “pulping” the ore particles with water. Before the frothing process, the aqueous ore particles are combined with a flotation composition, also referred to as a flotation agent or as a collector or collector agent, which comprises appropriate additives. These flotation agents selectively render the surfaces of the different types of particles hydrophobic and/or hydrophilic, based on their individual compositions. The frothing is done by passing stream of air or inert gas bubbles through the aqueous composition of ore and flotation agent, sometimes called “pulp,” in a flotation cell, such that the gas bubbles attach to and levitate the now-hydrophobic particles. These levitated particles, attached to the air bubbles, then collect in a froth layer which flows over the weir of the flotation cell. The undesirable gangue may be either unaffected by the flotation agent, or rendered hydrophilic and thus settles to the bottom of the flotation cell.

As discussed above, froth flotation works by separating minerals from gangue by exploiting differences in their hydrophobicity. Hydrophobicity differences between valuable minerals and waste gangue are increased through the use of surfactants and wetting agents which affect the various compounds in the crushed ore differently. The adhesion of the bubbles to the crystals is promoted by the action of the flotation agent or agents used. The crystals of the metal compounds then rise to the surface and are recovered in the form of a foam, also known as flotation concentrate. The gangue particles are recovered in the lower part of the flotation cell.

The flotation concentrate which flows over the weir at the top of the flotation cell has a content of desired metal which is therefore considerably higher than that in the starting ore. This content depends on the initial content in the ore and on the selectivity of the composition of the flotation agent.

After a stage of filtration and drying, the flotation concentrates are then introduced into the heat treatment (or smelting) stage. This stage is typically a furnace at temperatures which may exceed 1500° C. During this stage, the desired metal is separated in the molten state from the other substances, in particular from the impurities originating from the gangue of the ore, which have to be removed in the form of a slag.

U.S. Pat. No. 4,211,644 discloses a collector composition for use in concentrating metallic mineral ores by froth flotation which comprises a mixture of a mercaptan and an emulsifying or wetting agent adapted to improve the dispersion of the mercaptan into the pulp, and a froth flotation method for concentrating metallic mineral ores wherein the above collector composition is employed as the collector.

U.S. Pat. No. 4,554,137 discloses a process of enrichment of minerals by flotation by use of a collector comprising a thio-compound, the thio compound being a straight or branched dialkyl or dialkenyl polysulphide.

U.S. Pat. No. 4,556,500 discloses a composition and process for the recovery of the values of zinc, molybdenum, copper, lead, iron (pyrite), and iron-containing small amounts of gold or uranium, or both, from ores comprising these mineral sulfides. The aqueous composition is the impure form of an alkali metal alkyl trithiocarbonate compound. The process comprises employing the aqueous composition as a collection agent for the above minerals in an ore recovery process.

U.S. Pat. No. 4,594,151 discloses a process of flotation of minerals, which consists of introducing the flotation collector into the mineral pulp to be treated in the form of a microemulsifiable composition. In general, the collector agents are organic compounds containing sulfur, particularly mercaptans, thioethers or polysulfides, which generally are very slightly soluble in water.

U.S. Pat. No. 7,014,048 discloses compositions intended for the flotation of ores, including a combination (A) of n-dodecyl mercaptan (or NDM) and of tert-dodecyl mercaptan (or TDM), the NDM/TDM ratio by weight of which is between 0.5 and 1.5, a product (B) composed of one or more aromatic or aliphatic compounds comprising from 4 to 100 carbon atoms, and having one or two —OH groups.

U.S. Pat. No. 9,527,090 discloses a process for the recovery of a metal from an ore using a collector composition. The process includes contacting the ore with the collector composition. The collector composition includes specific sulfur-containing compounds.

Accordingly, it is important to use a flotation agent that provides a flotation concentrate having a suitably high content of the desired metal, so as to facilitate the subsequent operations of treatment of the said concentrate and of final isolation of the metal.

### SUMMARY

The inventors have found two compositions that may be used for flotation separation of minerals in ore. These compositions are based on specific mercaptans (thiols) and/or tri thiocarbonates. The mercaptans and the trithiocarbonates both exhibit desirable activity as flotation aids independently and in combination with one or more aromatic, aliphatic or polyalkylene oxide compounds.

A composition for flotation separation of minerals in ore is provided. The composition is mercaptan-based and comprises:
a) at least one mercaptan having a structure i), or ii), or combination thereof

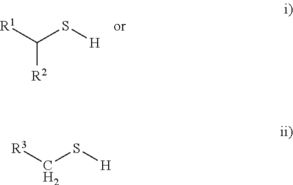

where R¹ and R² are independently selected from branched or straight chain C1-C23 alkyl groups, preferably from C1-C18, more preferably from C1-C15, most preferably from C1-C10; and where R³ is a C6-C24, preferably C6-C20, more preferably C6-C16, most preferably C6-C14 branched alkyl group; wherein an average number of carbon groups in the a) mercaptan is from 6 to 24, preferably from 6-19, more preferably from 6-16, most preferably from 6-14, preferably a) is 2-butyl-1-octanethiol, 2-dodecanethiol and/or 2-ethyl-1-decanethiol; and
b) one or more aromatic, aliphatic or polyalkylene oxide compounds comprising from 4 to 100 carbon atoms, and having one or two —OH groups, preferably polypropylene glycol, pine oil, cresylic acid, and/or methyl isobutyl carbinol.

Another composition for flotation separation of minerals in ore is also provided. This flotation composition is thiocarbonate-based and comprises:
d) at least one trithiocarbonate having a structure

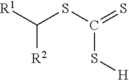

or salt thereof, or

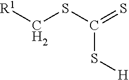

or salt thereof;
or combination thereof,
where R¹ and R² are independently selected from branched or straight chain C1-C23 alkyl groups, preferably from C1-C18, more preferably from C1-C15, most preferably from C1-C10, wherein an average number of carbon groups in the a) mercaptan is from 6 to 24, preferably from 6-19, more preferably from 6-16, most preferably from 6-14; and where R³ is a C6-C24, preferably C6-C20, more preferably C6-C16, most preferably C6-C14, branched alkyl group; and
b) one or more aromatic, aliphatic or polyalkylene oxide compounds comprising from 4 to 100 carbon atoms, and having one or two —OH groups.

Processes for flotation separation of minerals in an ore are also provided. The processes comprise: introducing into a flotation cell an effective amount of either of the above flotation compositions and the ore to be separated; and flotation separating some or all of the ore into a plurality of minerals.

### BRIEF DESCRIPTION OF THE DRAWINGS

FIG. 1 shows Cu recovery vs. flotation time obtained in Denver flotation machine using Examples 1-3;

FIG. 2 shows Mo recovery vs. flotation time obtained in Denver flotation machine using Examples 1-3;

FIG. 3 shows Fe recovery vs. flotation time obtained in Denver flotation machine using Examples 1-3;

FIG. 4 shows Fe recovery vs. Fe grade for all the Examples; and

FIG. 5 shows chalcopyrite recovery vs. pH in Hallimond tube for Examples 4 and 6, and comparison to an experiment using no collector.

### DETAILED DESCRIPTION

High molecular weight liquid mercaptans such as N-dodecyl mercaptan (NDM) and tertiary-dodecyl mercaptan (TDM) used as collectors in sulfide mineral froth flotation are known to offer outstanding recovery and selectivity for copper and molybdenum over iron and other gangue minerals. It is also recognized in the industry that NDM and TDM offer different performance in flotation kinetics, overall recovery and selectivity due to molecular differences that impact interaction with mineral particles and mobility in the flotation slurry.

The present invention discloses collector formulations comprising certain mercaptans and/or trithiocarbonates independently and in combination with one or more aromatic, aliphatic or polyalkylene oxide compounds that offer noticeable improvement in copper and molybdenum recovery kinetics over the commercial branched mercaptan TDM. Due to lower volatility, another benefit of these particular mercaptans and/or trithiocarbonates over TDM may be an improved odor profile. In addition, blends of these specific mercaptans and/or trithiocarbonates with additional additives can offer different performance required for different mineral compositions found in mines throughout the world. The blends may include other sulfur-containing collectors (such as xanthates, xanthate esters. dithiophosphates, dithiophosphinates, etc.), frothers (alcohols, glycols, polyglycols, etc.) and/or hydrocarbon blends used as diluents (alkanes, alkenes, diesel fuel, kerosene, etc.) in flotation separation processes.

Specifically relevant to this invention is the finding that di-octyl sulfides or DOS (which can be di-N-octyl sulfide or N-octyl, sec-octyl sulfide) can be blended with the specific mercaptans and/or trithiocarbonates in wide composition ranges forming stable liquid products that retain the differentiated performance of the specific mercaptans and/or trithiocarbonates compared to NDM and TDM.

As discussed briefly above, two compositions for flotation separation of mineral ores are disclosed herein. One of the compositions is mercaptan-based and the other composition is trithiocarbonate-based. The mercaptan-based composition may include the trithiocarbonate that is present in the trithiocarbonate composition. These two flotation compositions are related because the trithiocarbonate composition may be conveniently prepared by reacting the mercaptan-based-composition with CS₂ to provide the trithiocarbonate. According to certain embodiments, some or all of the mercaptan may be converted to the analogous trithiocarbonate. Thus, if all of the mercaptan in the mercaptan-based flotation composition is converted to the analogous trithiocarbonate, the trithiocarbonate flotation composition is produced. Of course, it is not necessary to produce the trithiocarbonate-based flotation composition directly from the mercaptan-based composition—the trithiocarbonate-based composition may be prepared directly by combining suitable components.

### Mercaptan-Based Flotation Composition

A mercaptan-based composition for flotation separation of minerals in ore is provided. The mercaptan-based composition comprises:
a) at least one mercaptan having a structure i), or ii), or combination thereof

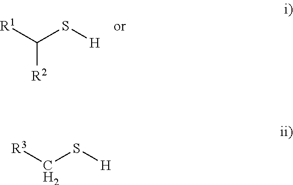

where R¹ and R² are independently selected from branched or straight chain C1-C23 alkyl groups, preferably from C1-C18, more preferably from C1-C15, most preferably from C1-C10; and where R³ is a C6-C24, preferably C6-C20, more preferably C6-C16, most preferably C6-C14 branched alkyl group; wherein an average number of carbon groups in the a) mercaptan is from 6 to 24, preferably from 6-19, more preferably from 6-16, most preferably from 6-14, preferably a) is 2-butyl-1-octanethiol, 2-dodecanethiol and/or 2-ethyl-1-decanethiol; and
b) one or more aromatic, aliphatic or polyalkylene oxide compounds comprising from 4 to 100 carbon atoms, and having one or two —OH groups, preferably polypropylene glycol, pine oil, cresylic acid, and/or methyl isobutyl carbinol.

According to an embodiment, the mercaptan-based flotation composition comprises from 30-99, preferably 30-90, more preferably 30-70 weight percent of the a) at least one mercaptan having structure i), based on a total weight of mercaptans in the composition.

According to an embodiment, the mercaptan-based flotation composition comprises from 5-95, preferably 5-75, more preferably 40-75 weight percent of the a) at least mercaptan having structure ii), based on a total weight of mercaptans in the composition.

According to another embodiment, the mercaptan-based flotation composition comprises from 1-35 weight percent, preferably from 10 to 30, more preferably from 15 to 25 of the b) one or more aromatic or aliphatic compounds comprising from 4 to 100 carbon atoms, and having one or two —OH groups, based on a total weight of the composition.

According to an embodiment, the mercaptan-based flotation composition further comprises c) at least one sulfide having a structure R⁴—S—R⁵,
where R⁴ and R⁵ are independently selected from C1-C16, preferably C1-C14, more preferably C1-C12, most preferably C1-C10 straight chain and branched alkyl groups, wherein an average number of carbons in the c) sulfide is from 10-24, preferably from 12-22, more preferably from 12-20, most preferably from 14-18.

According to an embodiment, the mercaptan-based flotation composition comprises from 1-99 weight percent, preferably from 25 to 75, more preferably from 40 to 60 of the c) at least one sulfide, based on a total weight of the composition, excluding a weight of the b) one or more aromatic or aliphatic compound comprising from 4 to 100 carbon atoms, and having one or two —OH groups.

According to an embodiment, the mercaptan-based flotation composition further comprises d) at least one thiocarbonate having a structure

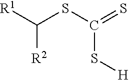

or salt thereof, or

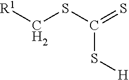

or salt thereof;
or combination thereof. If present in the mercaptan-based flotation composition, the trithiocarbonate comprises from 1-99 weight percent, preferably from 5-85 weight present, more preferably from 5 to 50 weight percent, most preferably from 5-25 weight percent of the d) at least one trithiocarbonate or salt thereof, based on a total weight of the mercaptan-based flotation composition, excluding a weight of the b) one or more aromatic or aliphatic compound comprising from 4 to 100 carbon atoms, and having one or two —OH groups.

According to an embodiment, the mercaptan-based composition further comprises e) at least one C6-C12 branched or straight chained alkane(s) and/or at least one branched or straight chained C6-C14 alkene(s), preferably dodecane, dodecene, and/or tetradecene.

### Trithiocarbonate-Based Flotation Composition:

Another composition for flotation separation of minerals in ore is also provided. This flotation composition is trithiocarbonate-based and comprises: d) at least one trithiocarbonate having a structure

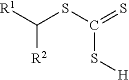

or salt thereof, or

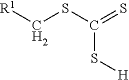

or salt thereof;
or combination thereof,
where R¹ and R² are independently selected from branched or straight chain C1-C23 alkyl groups, preferably from C1-C18, more preferably from C1-C15, most preferably from C1-C10, wherein an average number of carbon groups in the a) mercaptan is from 6 to 24, preferably from 6-19, more preferably from 6-16, most preferably from 6-14; and where R³ is a C6-C24, preferably C6-C20, more preferably C6-C16, most preferably C6-C14, branched alkyl group; and
b) one or more aromatic, aliphatic or polyalkylene oxide compounds comprising from 4 to 100 carbon atoms, and having one or two —OH groups.

According to an embodiment, the trithiocarbonate-based flotation composition may comprise from 1-99 weight percent, preferably from 5-95, more preferably from 10-90, most preferably from 20-80 of the d) at least one trithiocarbonate or salt thereof, based on a total weight of the composition, excluding a weight of the b) one or more aromatic or aliphatic compound comprising from 4 to 100 carbon atoms, and having one or two —OH groups.

According to an embodiment, the trithiocarbonate-based flotation composition may comprise from 1-40 weight percent, preferably 5-35 weight percent, more preferably 10-30 weight percent, most preferably 15-25 weight percent of the b) one or more aromatic or aliphatic compounds comprising from 4 to 100 carbon atoms, and having one or two —OH groups, based on a total weight of the composition.

According to an embodiment, the trithiocarbonate-based flotation composition may further comprise a) at least one mercaptan having a structure i), or ii), or combination thereof

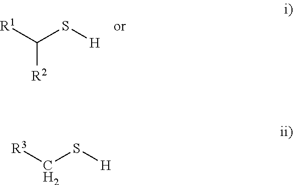

where R¹ and R² are independently selected from branched or straight chain C1-C23 alkyl groups, preferably from C1-C18, more preferably from C1-C15, most preferably from C1-C10, wherein an average number of carbon groups in the a) mercaptan is from 6 to 24, preferably from 6-19, more preferably from 6-16, most preferably from 6-14, preferably 2-butyl-1-octanethiol, 2-dodecanethiol and/or 2-ethyl-decanethiol; and where R³ is a C6-C24, preferably C6-C20, more preferably C6-C16, most preferably C6-C14, branched alkyl group. According to an embodiment, the trithiocarbonate-based flotation composition may comprise from 30-99, preferably 30-90, more preferably 30-70 weight percent of the a) at least one mercaptan having structure i), based on a total weight of mercaptans in the composition. According to an embodiment, the trithiocarbonate-based flotation composition may comprise from 5-95, preferably 5-75, more preferably 40-75 weight percent of the a) mercaptan having structure ii), based on a total weight of mercaptans in the composition.

According to an embodiment, the trithiocarbonate-based flotation composition may further comprise c) at least one sulfide having a structure R⁴—S—R⁵, where R⁴ and R⁵ are independently selected from C1-C16, preferably C1-C14, more preferably C1-C12, most preferably C1-C10 straight chain and branched alkyl groups, wherein an average number of carbons in the c) sulfide is from 10-25, preferably from 12-23, more preferably from 12-21, most preferably from 14-19. According to an embodiment, the trithiocarbonate flotation composition may comprise 1-99 weight percent, preferable 20-80, more preferably 30-70, most preferably 40-60 of the c) at least one sulfide, based on a total weight of the composition, excluding a weight of the b) one or more aromatic or aliphatic compound comprising from 4 to 100 carbon atoms, and having one or two —OH groups.

According to an embodiment, the trithiocarbonate may further comprise: f) at least one C6-C12 branched or straight chained alkane(s) and/or at least one branched or straight chained C6-C14 alkene(s), preferably dodecane, dodecene, and/or tetradecene.

### a) Mercaptan:

The mercaptans that may be used in the flotation compositions disclosed here have structure:

i), or ii), or combination thereof

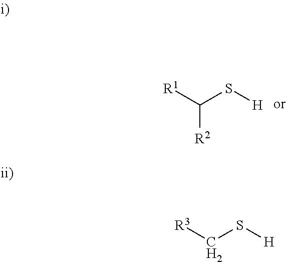

where R¹ and R² are independently selected from branched or straight chain C1-C23 alkyl groups, preferably from C1-C18, more preferably from C1-C15, most preferably from C1-C10, wherein an average number of carbon groups in the a) mercaptan is from 6 to 24, preferably from 6-19, more preferably from 6-16, most preferably from 6-14, preferably 2-butyl-1-octanethiol, 2-dodecanethiol and/or 2-ethyl-1-decanethiol; and where R³ is a C6-C24, preferably C6-C20, more preferably C6-C16, most preferably C6-C14, branched alkyl group.

For example, R¹ may be methyl or ethyl, or may be straight chained or branched C3, C4, C5, C6, C7, C8, C8, C10, C11, C12, C13, C14, C15, C16, C17, C18, C19, C20, C21, C22, or C23 alkyl group. R² may be methyl or ethyl, or may be straight chained or branched C3, C4, C5, C6, C7, C8, C8, C10, C11, C12, C13, C14, C15, C16, C17, C18, C19, C20, C21, C22, or C23 alkyl group. R³ may be straight chained or branched C6, C7, C8, C8, C10, C11, C12, C13, C14, C15, C16, C17, C18, C19, C20, C21, C22, C23, or C24 alkyl group. The average number of carbons in the a) mercaptan may be at least 6, 7, 8, 9, 10, 11, 12, 13, 14, or at least 16. The average number of carbons in the mercaptan a) is at most 24, 23, 22, 21, 20, 19, 18, 17, 16, 15, 14, 13, 12, or 11. According to an embodiment, the mercaptan a) preferably comprises at least one of 2-butyl-1-octanethiol, 2-dodecanethiol, 2-ethyl-1-decanethiol, or a combination thereof. According to an embodiment, the mercaptans may further comprise 3-dodecanethiol, 4-dodecanethiol, 5-dodecanethiol and/or 6-dodecanethiol.

According to some embodiments the mercaptan a) does not include NDM (n-dodecyl mercaptan) or TDM (tert-dodecyl mercaptan), although the mercaptan-based flotation composition or the trithiocarbonate-based flotation composition may optionally further comprise either or both of NDM and TDM in addition to the mercaptan a).

### b) Aromatic, Aliphatic or Polyalkylene Oxide Compounds

The aromatic, aliphatic, or polyalkylene oxide compound may comprise at least one of phenols optionally substituted by one or more C1-C4 alkyl radicals, cresols, naphthols, xylenols, indanols or mixtures of these compounds. Also suitable are polypropylene glycol (with weight average molecular weight between 100 and 1,000 g/mol), glycols, alcohols, The compound may comprise one or two —OH groups. The polyalkylene oxide compound may comprise one or more of a propylene oxide oligomer with a weight average molecular mass between 50 and 2000, preferably between 100 and 800; and/or 2-methyl-4-pentanol, a compound also known as methyl isobutyl carbinol or MIBC, of formula: CH₃—CH(OH)—CH₂—CH(CH₃)—CH₃ or may comprise polypropylene glycol.

### c) Sulfide

The c) sulfide compound has the structure R⁴—S—R⁵, where R⁴ and R⁵ are independently selected from C1-C16, preferably C1-C14, more preferably C1-C12, most preferably C1-C10 straight chain and branched alkyl groups, wherein an average number of carbons in the c) sulfide is from 10-24, preferably from 12-22, more preferably from 12-20, most preferably from 14-18. For example, R¹ and/or R² may be methyl, ethyl, C3, C4, C5, C6, C7, C8, C9, C10, C11, C12, C13, C14, C15, or C16 branched or straight-chained alkyl group. The average number of carbons in the sulfide c) may be at least 10, 11, 12, 13, 14, 15, 16, 17, 18, 19, or 20 carbons. The average number of carbons in the c) sulfide may be at most 24, 23, 22, 21, 20, 19, 18, 17, 16, 15, 14, 13, or 12 carbons. The c) sulfide may be a dioctyl sulfide, a dinonyl sulfide or a didecyl sulfide.

### d) Trithiocarbonate

The d) trithiocarbonate has structure:

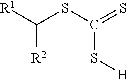

or salt thereof, or

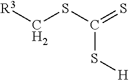

or salt thereof;
or combination thereof,
where R¹ and R² are independently selected from branched or straight chain C1-C23 alkyl groups, preferably from C1-C18, more preferably from C1-C15, most preferably from C1-C10, wherein an average number of carbon groups in the d) trithiocarbonate is from 6 to 24, preferably from 6-19, more preferably from 6-16, most preferably from 6-14; and where R³ is a C6-C24, preferably C6-C20, more preferably C6-C16, most preferably C6-C14, branched alkyl group. For example, R¹ may be methyl or ethyl, or may be straight chained or branched C3, C4, C5, C6, C7, C8, C8, C10, C11, C12, C13, C14, C15, C16, C17, C18, C19, C20, C21, C22, or C23 alkyl group. R² may be methyl or ethyl, or may be straight chained or branched C3, C4, C5, C6, C7, C8, C8, C10, C11, C12, C13, C14, C15, C16, C17, C18, C19, C20, C21, C22, or C23 alkyl group. R³ may be straight chained or branched C6, C7, C8, C8, C10, C11, C12, C13, C14, C15, C16, C17, C18, C19, C20, C21, C22, C23, or C24 alkyl group. The average number of carbons in the d) trithiocarbonate may be at least 6, 7, 8, 9, 10, 11, 12, 13, 14, 15, 16 or at least 17. The average number of carbons in the d) trithiocarbonate may be at most 25, 24, 23, 22, 21, 20, 19, 18, 17, 16, 15, 14, 13, 12, or 11. The d) trithiocarbonate may be in the form of a salt. If the d) trithiocarbonate is in the form of a salt, non-limiting examples of suitable counterions may comprise Na+, Li+, K+, Rb+, Mg2+, Ca2+, Ba2+, guanidinium CN₃H₆+, tetramethylammonium C₄NH₁₂+, or ammonium ion NH₄+. Na+ and K+ are preferred.

### e) Branched or Straight-Chained Alkane or Alkene

The e) branched or straight-chained alkane or alkene may comprise at least one C6-C12 branched or straight chained alkane(s) and/or at least one branched or straight chained C6-C14 alkene(s), preferably dodecane, dodecene, and/or tetradecane. For example the branched or straight-chained alkane may be a C6, C7, C8, C9, C10, C11, or C12 alkane. The branched or straight-chained alkene may be a C6, C7, C8, C9, C10, C11, or C12 alkene. The branched or straight chained alkene may comprise at least one or more unsaturations. The branched or straight-chained alkane or alkene may comprise dodecene (1-10 wt %), dodecane (1-10 wt %), and/or tetradecene (1-10 wt %).

### Additional Collectors:

According to some embodiments, the mercaptan-based flotation composition or the trithiocarbonate-based flotation composition optionally may further comprise one or more additional collectors. The optional additional collector may comprise one or more of xanthates, xanthate esters, xanthogen formates, dithiophosphates, monothiophosphates, dithiophosphinates, dithiocarbamates, mercaptobenzothiazoles, polysulfides, or thionocarbamates, for example. Non-limiting examples of specific compounds are ethyl xanthate, butyl xanthate, sodium isobutyl xanthate, sodium di-ethyldithiophosphate, potassium di-isobutyl dithiophosphate, potassium di-secbutyl dithiophosphate, diisobutyl monothiophosphate, sodium diisobutyl dithiophosphinate, potassium n-decyl dithiocarbamate, and O-isopropyl thionocarbamate.

According to some embodiments the optional additional collector may comprise mercaptans different from the mercaptan a) such as NDM (n-dodecyl mercaptan) or TDM (teit-dodecyl mercaptan).

### Methods:

A process for flotation separation of minerals in an ore, is provided. The method comprises: introducing into a flotation cell an effective amount of the mercaptan-based flotation composition and the ore to be separated; and flotation separating some or all of the ore into a plurality of minerals.

Another process for flotation separation of minerals in an ore is also provided. This method comprises: introducing into a flotation cell an effective amount of the trithiocarbonate-based flotation composition and the ore to be separated; and flotation separating some or all of the ore into a plurality of minerals.

Non-limiting examples of minerals that may be separated using the mercaptan-based or trithiocarbonate composition disclosed herein are to recover as much Cu and Mo as possible while selectively separating Fe (and other non-metallic minerals such as carbonates, silicates, etc.). Mo in general from all other minerals. In addition, Au alone or Cu—Au and Ag—Au minerals may be recovered while selectively separating Fe and other invaluable minerals. The main targets are Mo and Au when they are present with Cu or Ag. The flotation compositions disclosed herein may be used to separate Cu—Mo and/or Cu—Au and/or Au—Mo and/or Ag—Au ores. Non limiting examples of ores that may be separated by use of the flotation compositions are chalcopyrite, chalcocite, bornite, and molybdenite.

Certain non-limiting Aspects of the invention may be summarized as follows.

Aspect 1: A composition for flotation separation of minerals in ore comprising:
a) at least one mercaptan having a structure i), or ii), or combination thereof

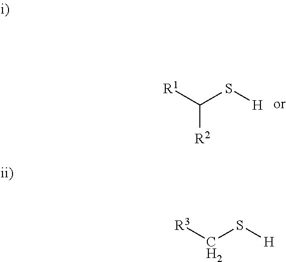

where R¹ and R² are independently selected from branched or straight chain C1-C23 alkyl groups, preferably from C1-C18, more preferably from C1-C15, most preferably from C1-C10; and where R³ is a C6-C24, preferably C6-C20, more preferably C6-C16, most preferably C6-C14 branched alkyl group; wherein an average number of carbon groups in the a) mercaptan is from 6 to 24, preferably from 6-19, more preferably from 6-16, most preferably from 6-14, preferably a) is 2-butyl-1-octanethiol, 2-dodecanethiol and/or 2-ethyl-1-decanethiol;
b) one or more aromatic, aliphatic or polyalkylene oxide compounds comprising from 4 to 100 carbon atoms, and having one or two —OH groups, preferably polypropylene glycol, pine oil, cresylic acid, and/or methyl isobutyl carbinol; and
optionally, one or more additional collectors different from the at least one mercaptan a), comprising at least one of xanthates, xanthate esters, xanthogen formates, dithiophosphates, monothiophosphates, dithiophosphinates, dithiocarbamates, mercaptobenzothiazoles, polysulfides, thionocarbamates, NDM (n-dodecyl mercaptan), or TDM (tert-dodecyl mercaptan).

Aspect 2: The composition of Aspect 1, further comprising:
c) at least one sulfide having a structure R⁴—S—R⁵,
   where R⁴ and R⁵ are independently selected from C1-C16, preferably C1-C14, more preferably C1-C12, most preferably C1-C10 straight chain and branched alkyl groups, wherein an average number of carbons in the c) sulfide is from 10-24, preferably from 12-22, more preferably from 12-20, most preferably from 14-18.

Aspect 3: The composition of Aspect 1 or Aspect 2, further comprising:
d) at least one trithiocarbonate having a structure

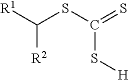

or salt thereof, or

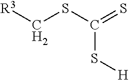

or salt thereof;
or combination thereof.

Aspect 4: The composition of any of Aspects 1-3, further comprising e) at least one C6-C12 branched or straight chained alkane(s) and/or at least one branched or straight chained C6-C14 alkene(s), preferably dodecane, dodecene, and/or tetradecene.

Aspect 5: The composition of any of Aspects 1-4 comprising from 30-99, preferably 30-90, more preferably 30-70 weight percent of the a) at least one mercaptan having structure i), based on a total weight of mercaptans in the composition.

Aspect 6: The composition of any of Aspects 1-5, comprising from 1-25 weight percent of the b) one or more aromatic or aliphatic compounds comprising from 4 to 100 carbon atoms, and having one or two —OH groups, based on a total weight of the composition.

Aspect 7: The composition of any of Aspects 2-6, comprising from 1-99 weight percent of the c) at least one sulfide, based on a total weight of the composition, excluding a weight of the b) one or more aromatic or aliphatic compound comprising from 4 to 100 carbon atoms, and having one or two —OH groups.

Aspect 8: The composition of any of Aspects 3-7, comprising from 1-99 weight percent of the d) at least one trithiocarbonate or salt thereof, based on a total weight of the composition, excluding a weight of the b) one or more aromatic or aliphatic compound comprising from 4 to 100 carbon atoms, and having one or two —OH groups.

Aspect 9: The composition of any of Aspects 4-8, comprising from 5-95, preferably 5-75, more preferably 40-75 weight percent of the a) at least one mercaptan having structure ii), based on a total weight of mercaptans in the composition.

Aspect 10: A process for flotation separation of minerals in an ore, comprising:
introducing into a flotation cell an effective amount of the composition of any of Aspects 1-9 and the ore to be separated; and
flotation separating some or all of the ore into a plurality of minerals.

Aspect 11: A composition for flotation separation of minerals in ore comprising:
d) at least one trithiocarbonate having a structure

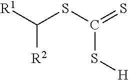

or salt thereof, or

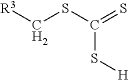

or salt thereof;
or combination thereof,
where R¹ and R² are independently selected from branched or straight chain C1-C23 alkyl groups, preferably from C1-C18, more preferably from C1-C15, most preferably from C1-C10, wherein an average number of carbon groups in the a) mercaptan is from 6 to 25, preferably from 6-20, more preferably from 6-17, most preferably from 6-15; and where R³ is a C6-C24, preferably C6-C20, more preferably C6-C16, most preferably C6-C14, branched alkyl group;
b) one or more aromatic, aliphatic or polyalkylene oxide compounds comprising from 4 to 100 carbon atoms, and having one or two —OH groups; and
optionally, one or more additional collectors, comprising at least one of xanthates, xanthate esters, xanthogen formates, dithiophosphates, monothiophosphates, dithiophosphinates, dithiocarbamates, mercaptobenzothiazoles, polysulfides, thionocarbamates, NDM (n-dodecyl mercaptan), or TDM (tert-dodecyl mercaptan).

Aspect 12: The composition of Aspect 11, further comprising:
c) at least one sulfide having a structure R⁴—S—R⁵,
   where R⁴ and R⁵ are independently selected from C1-C16, preferably C1-C14, more preferably C1-C12, most preferably C1-C10 straight chain and branched alkyl groups, wherein an average number of carbons in the c) sulfide is from 10-24, preferably from 12-22, more preferably from 12-20, most preferably from 14-18.

Aspect 13: The composition of Aspect 11 or Aspect 12, further comprising:
a) at least one mercaptan having a structure i), or ii), or combination thereof

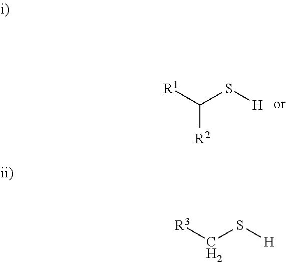

where R¹ and R² are independently selected from branched or straight chain C1-C23 alkyl groups, preferably from C1-C18, more preferably from C1-C15, most preferably from C1-C10, wherein an average number of carbon groups in the a) mercaptan is from 6 to 24, preferably from 6-19, more preferably from 6-16, most preferably from 6-14, preferably 2-butyl-1-octanethiol, 2-dodecanethiol and/or 2-ethyl-decanethiol; and where R³ is a C6-C24, preferably C6-C20, more preferably C6-C16, most preferably C6-C14, branched alkyl group.

Aspect 14: The composition of any of Aspects 11-13, further comprising e) at least one C6-C12 branched or straight chained alkane(s) and/or at least one branched or straight chained C6-C14 alkene(s), preferably dodecane, dodecene, and/or tetradecene.

Aspect 15: The composition of any of Aspects 11-14, comprising from 1-25 weight percent of the b) one or more aromatic or aliphatic compounds comprising from 4 to 100 carbon atoms, and having one or two —OH groups, based on a total weight of the composition.

Aspect 16: The composition of any of Aspects 12-15, comprising from 1-99 weight percent of the c) at least one sulfide, based on a total weight of the composition, excluding a weight of the b) one or more aromatic or aliphatic compound comprising from 4 to 100 carbon atoms, and having one or two —OH groups.

Aspect 17: The composition of any of Aspects 11-16, comprising from 1-99 weight percent of the d) at least one trithiocarbonate or salt thereof, based on a total weight of the composition, excluding a weight of the b) one or more aromatic or aliphatic compound comprising from 4 to 100 carbon atoms, and having one or two —OH groups.

Aspect 18: The composition of any of Aspects 13-17 comprising from 30-99, preferably 30-90, more preferably 30-70 weight percent of the a) at least one mercaptan having structure i) based on a total weight of mercaptans in the composition.

Aspect 19: The composition of any of Aspects 13-18, comprising from 5-95, preferably 5-75, more preferably 40-75 weight percent of the a) mercaptan having structure ii), based on a total weight of mercaptans in the composition.

Aspect 20: A process for flotation separation of minerals in an ore, comprising:
introducing into a flotation cell an effective amount of the composition of any of Aspects 11-19 and the ore to be separated; and flotation separating some or all of the ore into a plurality of minerals.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the compositions, methods for making the compositions, methods for using the compositions, and articles prepared from the compositions. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### Examples

The following experiments were carried out in a 2.5 L Denver-type flotation cell. These experiments were performed using different formulations to evaluate the impact of a mixture of mercaptans according to the invention (2-butyl-1-octanethiol, 2-dodecanethiol and 2-ethyl-1-decanethiol) with hydrocarbons (branched or straight-chained alkanes or alkenes containing between 8 and 14 carbon atoms) and monosulfides (containing between 16 and 28 carbon atoms) on performance of the recovery of a mineral that was rich in copper (Cu), molybdenum (Mo) and iron (Fe). Two comparative examples (Examples 1 and 2) and three inventive examples (Examples 3-5) were tested as indicated in Table 1. Examples 1 and 2 used commercial mercaptan products well-known in the art, NDM (n-dodecyl mercaptan) and TDM (tert-dodecyl mercaptan). Example 3 includes higher amounts of a mixture of 2-butyl-1-octanethiol, 2-dodecanethiol and 2-ethyl-1-decanethiol with low amount of hydrocarbons and moderate amount of monosulfide. Example 4 contains a mixture of 2-butyl-1-octanethiol, 2-dodecanethiol and 2-ethyl-decanethiol and has the highest hydrocarbon content, and Example 5 contains a mixture of 2-butyl-1-octanethiol, 2-dodecanethiol and 2-ethyl-1-decanethiol and has the highest monosulfide content. Table 2 shows the amounts of each of the mercaptan components in Examples 3-5. The hydrocarbon components in the Examples were dodecane and tetradecene.

TABLE 1
Compositions of Examples 1-5

| | Example 1 | Example 2 | | | |
|---|---|---|---|---|---|
| | (compar- | (compar- | Example 3 | Example 4 | Example 5 |
| | ative) | ative) | (invention) | (invention) | (invention) |
| Hydrocarbon | 0.0 | 4.0 | 0.9 | 6.4 | 0.7 |
| (wt %) | | | | | |
| Mixture of | 1.2 | 10 | 82.8 | 76.7 | 75.1 |
| mercaptans | | | | | |
| in Table 2 | | | | | |
| (wt %) | | | | | |
| NDM | 98.5 | 0.0 | 8.3 | 7.7 | 8.1 |
| (wt %) | | | | | |
| TDM | 0.0 | 86.0 | 0.0 | 0.0 | 0.0 |
| (wt %) | | | | | |
| Other | 0.0 | 0.0 | 2.2 | 6.2 | 2.0 |
| mercaptans | | | | | |
| (wt %) | | | | | |
| Monosulfides | 0.3 | 0.0 | 5.8 | 3.0 | 13.6 |
| (wt %) | | | | | |
| Disulfides | 0.0 | 0.0 | 0.0 | 0.0 | 0.6 |
| (wt %) | | | | | |

TABLE 2
Mixture of Mercaptans in Examples 3-5

| | Example 3 | Example 4 | Example 5 |
|---|---|---|---|
| 2-butyl-1-octanethiol | 21.5 | 28.4 | 21.9 |
| (wt %) | | | |
| 2-dodecanthiol (wt %) | 58.9 | 48.1 | 58.8 |
| 2-ethyl-1-decanethiol | 19.6 | 23.5 | 19.3 |
| (wt %) | | | |

In the flotation procedure, 700 g of ore in 460 ml of water were ground in a rod mill for 30 minutes in the presence of kerosene and lime to maintain pH at 11.2. The pulp was then transferred from the mill to the 2.5 L flotation cell for testing. The examples in this invention were added to the flotation cell as formulations containing 20% polypropylene glycol (PPG) having a weight average molecular weight of 425 g/mol. After conditioning for 3 minutes, additional PPG was added as a frother just before starting the collections experiments and collecting for 12 minutes. The total amount of reagents used in the flotation experiments is shown in Table 3.

TABLE 3
Froth flotation reagents used in flotation machine experiments

| | Total dosage |
|---|---|
| Reagent | (g/ton) |
| Kerosene | 25.0 |
| | (collector) |
| Examples | 15.0 |
| (collector) | |
| PPG (frother) | 30.0 |

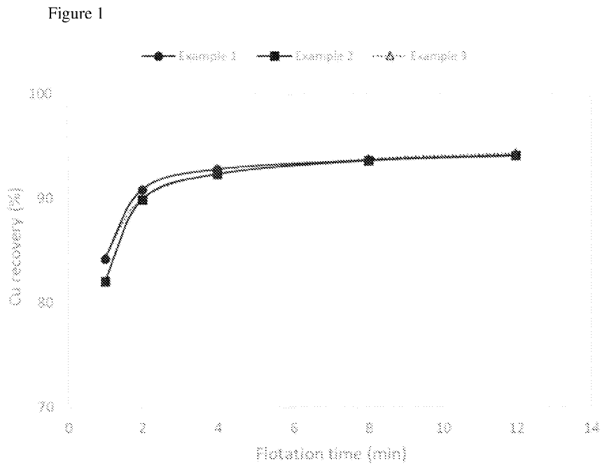

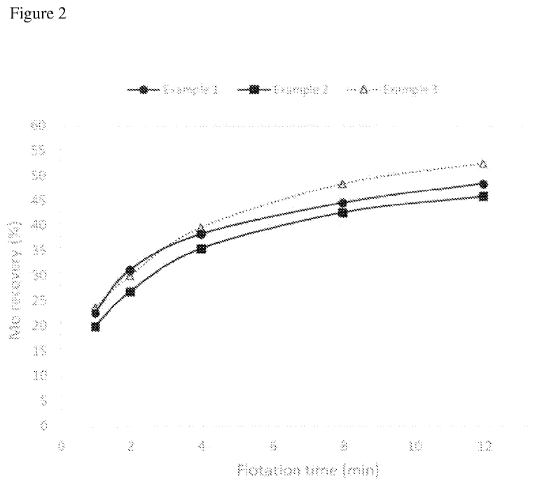

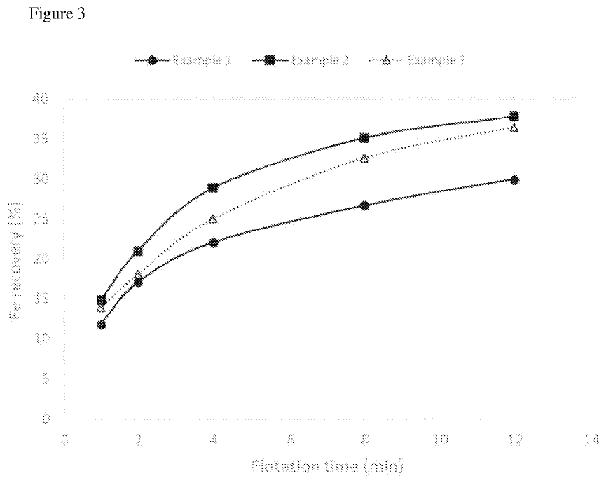

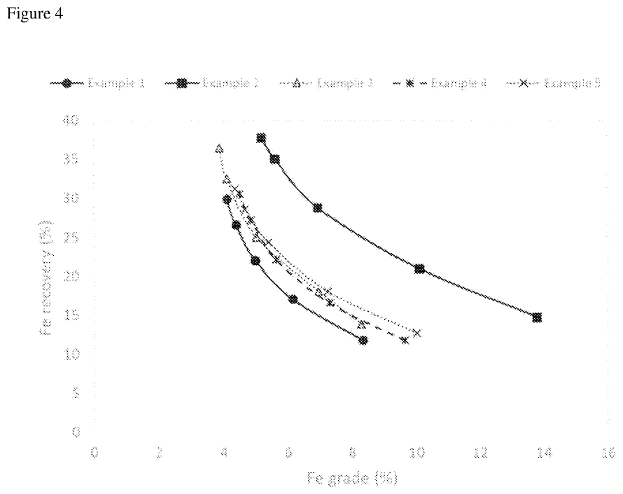

The results are shown in FIGS. 1-3 which show curves of metal recovery vs. flotation time using commercial NDM (Example 1), commercial TDM (Example 2) and blended mercaptans (Example 3). It can be seen from these figures that although Cu and Mo recovery are similar for all mercaptans, the selectivity against Fe follows a clear trend: the TDM product has the highest total recovery and kinetics, while the NDM product has the lowest. Interestingly, the mixed mercaptans product of the invention has a differentiated performance in between both commercial products. FIG. 4 shows Fe recovery vs. Fe grade for all the examples, and it is clear that the formulations containing the inventive mixed mercaptans fall in the same line, with performance in between that of NDM and TDM.

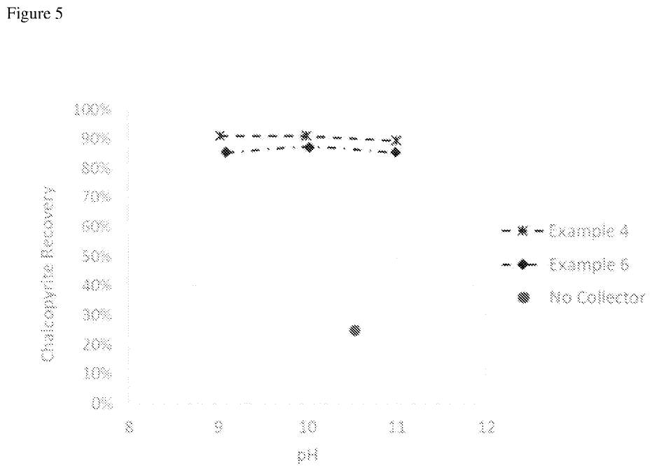

Finally, a formulation that contained over 50% monosulfides (Example 6) was tested as collector for chalcopyrite (CuFeS₂) using a Hallimond tube flotation device. This example was compared to Example 4 to test how the high quantity of monosulfides would affect the performance. As seen in FIG. 5, Example 6 performed comparably to Example 4, outperforming an experiment using no collectors.

TABLE 4
Example 6 composition

| | Example 6 (wt %) |
|---|---|
| Hydrocarbon | 3.67 |
| Mixed mercaptans (Table 2) | 37.75 |
| NDM | 3.75 |
| Other mercaptans | 3.09 |
| Di-n-octyl sulfide | 50.0 |
| Other mono sulfides | 1.67 |
| Disulfide | 0.10 |

1. A composition for flotation separation of minerals in ore comprising:
a) at least one mercaptan having a structure i), or ii), or combination thereof 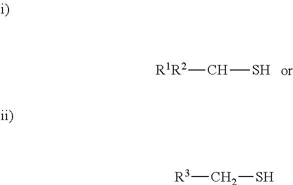
where R¹ and R² are independently selected from branched or straight chain C1-C23 alkyl groups, wherein R³ is a C6-C24 branched alkyl group; and wherein an average number of carbon groups in the a) mercaptan is from 6 to 24;
b) one or more aromatic, aliphatic or polyalkylene oxide compounds comprising from 4 to 100 carbon atoms, and having one or two —OH groups; and
optionally, one or more additional collectors different from the at least one mercaptan a), comprising at least one of xanthates, xanthate esters, xanthogen formates, dithiophosphates, monothiophosphates, dithiophosphinates, dithiocarbamates, mercaptobenzothiazoles, polysulfides, thionocarbamates, NDM (n-dodecyl mercaptan), and TDM (tert-dodecyl mercaptan).

2. The composition of claim 1, further comprising:
c) at least one sulfide having a structure R⁴—S—R⁵,
wherein R⁴ and R⁵ are independently selected from C1-C16 straight chain and branched alkyl groups, wherein an average number of carbons in the c) sulfide is from 10-24.

3. The composition of claim 1, further comprising:
d) at least one trithiocarbonate having a structure: 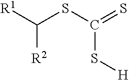
or salt thereof; or 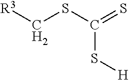
or salt thereof;
or combination thereof.

4. The composition of claim 1, further comprising e) at least one C6-C12 branched or straight chained alkane(s) and/or at least one branched or straight chained C6-C14 alkene(s).

5. The composition of claim 1, comprising from 30-99 weight percent of the a) at least one mercaptan having structure i), based on a total weight of mercaptans in the composition.

6. The composition of claim 1, comprising from 1-25 weight percent of the b) one or more aromatic or aliphatic compounds comprising from 4 to 100 carbon atoms, and having one or two —OH groups, based on a total weight of the composition.

7. The composition of claim 2, comprising from 1-99 weight percent of the c) at least one sulfide, based on a total weight of the composition, excluding a weight of the b) one or more aromatic or aliphatic compound comprising from 4 to 100 carbon atoms, and having one or two —OH groups.

8. The composition of claim 3, comprising from 1-99 weight percent of the d) at least one trithiocarbonate or salt thereof, based on a total weight of the composition, excluding a weight of the b) one or more aromatic or aliphatic compound comprising from 4 to 100 carbon atoms, and having one or two —OH groups.

9. The composition of claim 4, comprising from 5-95 weight percent of the a) at least one mercaptan having structure ii), based on a total weight of mercaptans in the composition.

10. A process for flotation separation of minerals in an ore, comprising:
introducing into a flotation cell an effective amount of the composition of claim 1 and the ore to be separated; and
flotation separating some or all of the ore into a plurality of minerals.

11. A composition for flotation separation of minerals in ore comprising:
d) at least one trithiocarbonate having a structure 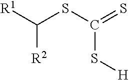
or salt thereof; or 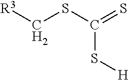
or salt thereof;
or combination thereof, wherein R¹ and R² are independently selected from branched or straight chain C1-C23 alkyl groups, wherein an average number of carbon groups in the a) mercaptan is from 6 to 25; and wherein R³ is a C6-C24 branched alkyl group;
b) one or more aromatic, aliphatic or polyalkylene oxide compounds comprising from 4 to 100 carbon atoms, and having one or two —OH groups; and
optionally, one or more additional collectors, comprising at least one of xanthates, xanthate esters, xanthogen formates, dithiophosphates, monothiophosphates, dithiophosphinates, dithiocarbamates, mercaptobenzothiazoles, polysulfides, thionocarbamates, NDM (n-dodecyl mercaptan), and TDM (tert-dodecyl mercaptan).

12. The composition of claim 11, further comprising:
c) at least one sulfide having a structure R⁴—S—R⁵,
wherein R⁴ and R⁵ are independently selected from C1-C16 straight chain and branched alkyl groups, wherein an average number of carbons in the c) sulfide is from 10-24.

13. The composition of claim 11, further comprising:
a) at least one mercaptan having a structure i), or ii), or combination thereof 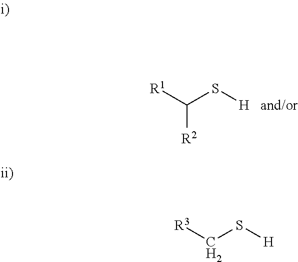
wherein R¹ and R² are independently selected from branched or straight chain C1-C23 alkyl groups; wherein an average number of carbon groups in the a) mercaptan is from 6 to 24; and wherein R³ is a C6-C24 branched alkyl group.

14. The composition of claim 11, further comprising e) at least one C6-C12 branched or straight chained alkane(s) and/or at least one branched or straight chained C6-C14 alkene(s).

15. The composition of claim 11, comprising from 1-25 weight percent of the b) one or more aromatic or aliphatic compounds comprising from 4 to 100 carbon atoms, and having one or two —OH groups, based on a total weight of the composition.

16. The composition of claim 12, comprising from 1-99 weight percent of the c) at least one sulfide, based on a total weight of the composition, excluding a weight of the b) one or more aromatic or aliphatic compound comprising from 4 to 100 carbon atoms, and having one or two —OH groups.

17. The composition of claim 11, comprising from 1-99 weight percent of the d) at least one trithiocarbonate or salt thereof, based on a total weight of the composition, excluding a weight of the b) one or more aromatic or aliphatic compound comprising from 4 to 100 carbon atoms, and having one or two —OH groups.

18. The composition of claim 13, comprising from 30-99 weight percent of the a) at least one mercaptan having structure i) based on a total weight of mercaptans in the composition.

19. The composition of claim 13, comprising from 5-95 weight percent of the a) mercaptan having structure ii), based on a total weight of mercaptans in the composition.

20. A process for flotation separation of minerals in an ore, comprising:
introducing into a flotation cell an effective amount of the composition of claim 11 and the ore to be separated; and
flotation separating some or all of the ore into a plurality of minerals.
